(19) United States
(12) Patent Application Publication
(10) Pub. No.: US 2021/0177693 A1
(43) Pub. Date: Jun. 17, 2021

(54) Apparatus System and Method for Vibroacoustic Therapy of the Spinal Column

(71) Applicant: David Clark, Lowell, MA (US)

(72) Inventor: David Clark, Lowell, MA (US)

(21) Appl. No.: 17/121,418

(22) Filed: Dec. 14, 2020

Related U.S. Application Data
(60) Provisional application No. 62/947,820, filed on Dec. 13, 2019.

(51) Int. Cl. A61H 23/02

(52) U.S. Cl. CPC A61H 23/0236; A61H 2205/081; A61H 2201/501; A61H 2201/0214; A61H 2201/0207

(57) ABSTRACT

The apparatus comprises a controller; a spinal cradle rod; at least one vertebral module, the at least one vertebral module comprising at least one tension arm and at least one sensory pad, the at least one sensory pad comprising at least one emitter. The at least one vertebral module is in mechanical communication with and affixed to the spinal cradle rod; the at least one emitter is in electrical communication with the controller; and the controller provides input signals to the at least one emitter. The spinal cradle rod is the structural base of the therapeutic system and can be set to the proper curvature of the spine, and is adjustable according to the height and weight of the user.

### RELATED APPLICATION

This application claims the benefit of U.S. Provisional Application No. 62/947,820 filed on Dec. 13, 2019. The entire teachings of the above application are incorporated herein by reference.

### BACKGROUND OF THE INVENTION

It is well known that all the organs that make up the human body are coordinated through the nerves running through specific vertebrae and intervertebral discs in the spinal column. Misalignment of vertebrae in the spinal column or inflammation of one or more intervertebral discs may contribute to issues elsewhere in the body by impeding the function of the nervous system. Typically, chiropractic treatment and thermal (ice/heat, e.g.) therapy are used to treat such issues. However, because chiropractic practices are normally traumatizing to the tissues surrounding the area of treatment or adjustment, those methods can be undesirable to many.

There thus exists a long-felt need for encouraging spinal alignment and health through alternative, low impact, non-invasive, targeted and concerted combinations of therapies going beyond chiropractic adjustments, ice and heat.

Vibroacoustic therapy may combine sounds, music, and pulses of fixed or varying frequencies both above and below the audio spectrum. The vibracoustic therapy is designed to resonate in specific tissues and bony components of the spinal column and may be administered through speakers, transducers, or a combination thereof, that are placed either in direct contact with, or in proximity to, the desired areas of treatment. To facilitate delivery of the therapy, speakers and transducers may be built into an apparatus which cradles the spinal column and allows therapeutic targeting of individual vertebrae or the soft tissues of the intervertebral discs. Such vibroacoustic therapy alone may be helpful for a variety of conditions typically associated with vertebral alignment, such as sports injury and muscular strain.

### SUMMARY OF THE INVENTION

The current invention provides an apparatus designed to focus various forms of treatment, including but not limited to, sound, vibration, heat, and massage along the spinal column with the goal of encouraging proper curvature of the spine with no more force than the weight of the user and to provide therapeutic stimulation to the various nerves present in the spinal column.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a side-view of the apparatus adjacent to a human spine and showing placement of the at least one vertebral module and the spinal cradle rod.

FIG. 2 is a top-down view of a vertebral module adjacent to a vertebra and showing the at least one emitter, the at least one tension arm, the spinal cradle rod, and the intended projection path of the chosen therapy.

FIG. 3 is an overhead view of the carriage and the apparatus affixed to it.

### DETAILED DESCRIPTION OF THE INVENTION

Following are detailed description of preferred embodiments, which are meant to be descriptive and not limiting.

The apparatus 1 is a therapeutic device designed to focus various forms of treatment along the spinal column which help to encourage proper curvature of the spine 11 with no more force than the weight of the user and to provide therapeutic stimulation to the various nerves present in the spinal column.

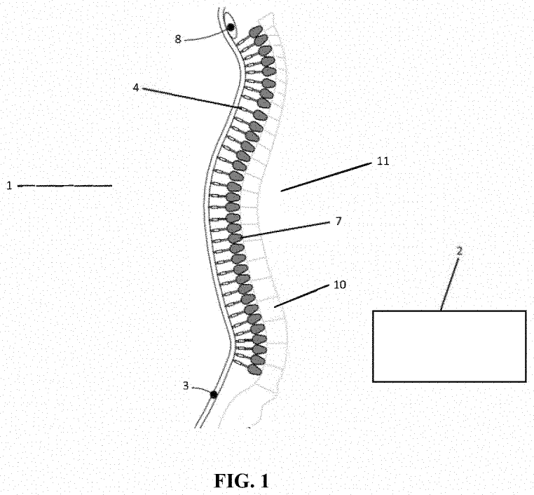

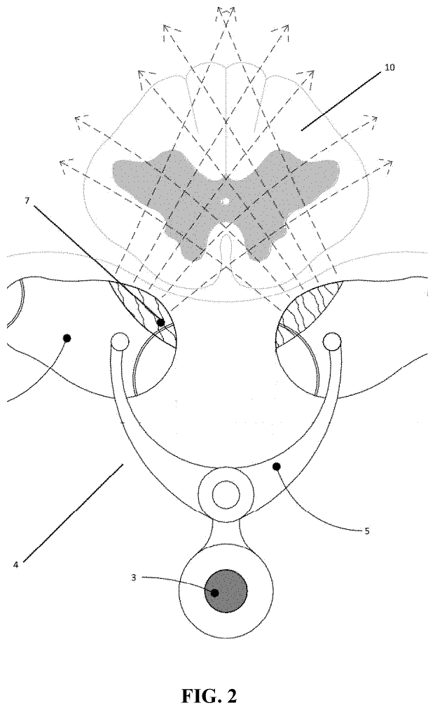

In a preferred embodiment and as shown in FIG. 1 and FIG. 2, the apparatus 1 for vibroacoustic therapy on the spinal column of a user comprises a controller 2; a spinal cradle rod 3; and at least one vertebral module 4. The at least one vertebral module 4 comprises at least one tension arm 5 and at least one sensory pad 6. The at least one sensory pad 6 comprises at least one emitter 7. The at least one vertebral module 4 is in mechanical communication with and affixed to the spinal cradle rod, the at least one emitter 7 is in electrical communication with the controller 2, and the controller 2 provides input signals to the at least one emitter 7.

In another preferred embodiment, the at least one emitter 7 comprises one or more of: a speaker; a transducer; an EMP element; a vibratory element; a heating element; or a cooling element. While the other emitters described are used to transmit sound and, the vibratory element, the electromagnetic pulse (EMP) element, the heating element, and the cooling element are used to stimulate the muscle into flexing and relaxing.

In yet another embodiment, the at least one vertebral module 4 is movable with respect to the spinal cradle rod 3 and may be affixed to any point on the spinal cradle rod 3. Preferably, the movement and affixing are done through an internal thread on the spinal cradle rod 3 as can be seen in FIG. 2. The spinal cradle rod 3 promotes the proper curvature of the spine 11. The internal thread therefore allows lengthening or shortening of the spaces between each at least one vertebral module 4.

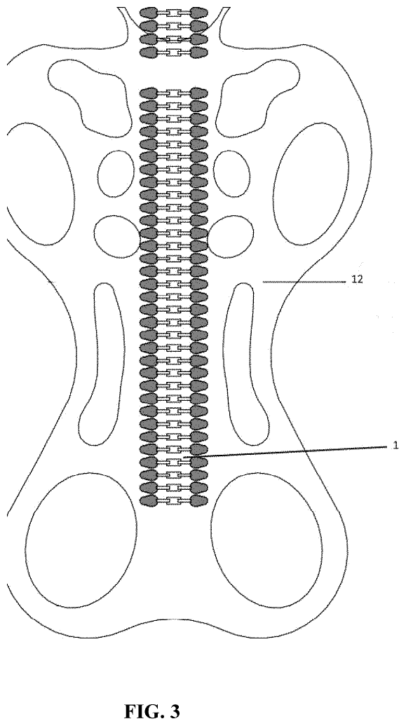

In another preferred embodiment as shown in FIG. 3, the apparatus 1 further comprises and is affixed to a stability carriage 12. The stability carriage 12 provides a semi-rigid platform for mounting and helps to ensure that the mechanical configuration of the apparatus 1 remains constant. The stability carriage 12 would allow the apparatus 1 to be adjusted and then easily mounted to a piece of furniture, such as a therapeutic chair.

In another embodiment, the apparatus 1 further comprises a controller 2 interface. The interface would preferably be an app, such as found on mobile devices, laptops, and the like. The interface would preferably allow the user to control the inputs to each at least one emitter 7. The vibroacoustic therapy delivered is adjustable to provide any combination of sound, vibration, heat, or massage to a specific at least one vertebral module 4 or in concert with each other. A user may create a profile that includes an initial scan of their current spinal alignment and tension. Collected data may be shared for the sake of sound therapy research.

In another embodiment of the apparatus 1, the at least one sensory pad 6 may further comprise an electromechanical sensor for detecting a user's current state of spinal alignment and the tension of the soft tissue at the sensor location.

In another embodiment and as shown in the drawings, the apparatus 1 may further comprise additional sensory pad 6 modules for a head rest 8 and a hip rest 9. The head rest 8 provides support for the base of the skull and the hip rest 9 provides support for the base of the spinal column and the hips. Both the head rest 8 and the hip rest 9 are configured and spaced to ensure alignment of the apparatus 1 along the user's spine 11 and contact of the at least one vertebral module 4 to the user.

In another embodiment, each vertebral module 4 may rotate, at its connection point to the tension arm 5 on its off-center axis to create a “kneading” motion to gently massage the soft muscle tissue away from the spinal column to provide stress relief and to promote improved circulation of the soft tissue around the spinal column.

In a preferred embodiment, the controller 2 for the apparatus 1 is app based. The vibroacoustic therapy delivered is adjustable to provide any combination of sound, vibration, heat, or massage to specific vertebral module 4s or in concert with each other. A user may create a profile that includes an initial scan of their current spinal alignment and tension. Collected data may be shared for the sake of sound therapy research.

While this invention has been particularly shown and described with references to preferred embodiments thereof, it will be understood by those skilled in the art that various changes in form and details may be made therein without departing from the scope of the invention encompassed by the appended claims.

It should be understood that any preferred features of the invention described herein can be combined with any other preferred features, including preferred features described only under one aspect of the invention, and preferred features described only in the examples. Throughout the specification, any and all references to a publicly available document, including any U.S. patent or patent application publication, are specifically incorporated by reference.

### REFERENCES

Dale, Cyndi et. al, The Subtle Body: An Encyclopedia of Your Energetic Anatomy, Sounds True, 2009
Goldman, Joshua et. al, Sound Healing for Beginners: Using Vibration to Harmonize Your Health and Wellness, Llewellyn, 2016
Simpson, Liz et, al, The Book of Chakra Healing. Gaia, 2017

What is claimed is:

1. An apparatus for vibroacoustic therapy on the spinal column of a user, the apparatus comprising: a controller; a spinal cradle rod; at least one vertebral module, the at least one vertebral module comprising at least one tension arm and at least one sensory pad, the at least one sensory pad comprising at least one emitter; and
wherein the at least one vertebral module is in mechanical communication with and affixed to the spinal cradle rod; the at least one emitter is in electrical communication with the controller; and the controller provides input signals to the at least one emitter.

2. The apparatus of claim 1, wherein the at least one emitter comprises one or more of: a speaker; a transducer; an EMP element; a vibratory element; a heating element; or a cooling element.

3. The apparatus of claim 1, wherein the at least one vertebral module is movable with respect to the spinal cradle rod and may be affixed to any point on the spinal cradle rod.

4. The apparatus of claim 1, further comprising a stability carriage, wherein the spinal cradle rod is affixed to the stability carriage.

5. The apparatus of claim 1, further comprising a controller interface, wherein the user may control the inputs to each at least one emitter.

6. The apparatus of claim 5, wherein the controller interface is an app.
